(19) United States
(12) Patent Application Publication
(10) Pub. No.: US 2025/0091206 A1
(43) Pub. Date: Mar. 20, 2025

(54) TEACHING DEVICE

(71) Applicant: FANUC CORPORATION, Yamanashi (JP)

(72) Inventors: Yuutarou TAKAHASHI, Yamanashi (JP); Yuta NAMIKI, Yamanashi (JP); Shoutarou OGURA, Yamanashi (JP); Yuusuke MURATA, Yamanashi (JP)

(21) Appl. No.: 18/293,356

(22) PCT Filed: Aug. 27, 2021
(86) PCT No.: PCT/JP2021/031598

§ 371 Date: Jan. 30, 2024

(51) Int. Cl. B25J 9/16; B25J 13/06; G06F 3/04817

(52) U.S. Cl. CPC B25J 9/1661; B25J 13/06; G06F 3/04817

(57) ABSTRACT

A teaching device for performing program creation using an icon representing a function constituting a control program for an industrial machine is provided, the teaching device including: a state information acquisition unit that acquires state information indicating whether or not the icon constituting the control program can execute an anticipated action, or has performed execution thereof or not; and an information display creating unit that creates a display relating to the icon, so that whether or not the icon making can execute the anticipated action or has performed execution thereof or not can be visually recognized on the program creating screen, on the basis of the state information.

### FIELD

The present invention relates to a teaching device.

### BACKGROUND

A teaching device that, in order to intuitively teach a control program of a robot, enables programming using icons representing functions constituting the control program of the robot has been proposed (for example, PTL 1).

Regarding use of icons, the following prior art documents have been disclosed. PTL 2 describes that a user interface in an arc welding system “may include a display that graphically presents parameters, such as a robot parameter, a welding parameter, and a plasma cutting parameter, to an operator in a form of picture writing and visually shows how a change of the parameters influences a robot process, a welding process, a plasma process, and the like to the operator” (paragraph 0023).

PTL 3 describes, with regard to an operation state analysis device that records information representing operation of a robot and analyzes a state of the robot, based on the recorded information, that “next, as illustrated in FIG. 6, image data and elapsed time (or time) information are displayed in a display screen of the operation state analysis device 1 in a list form as a list of icons by arranging images chronologically in the order of acquisition of the data” (paragraph 0014) and “when the analysis button is selected (step 208), as illustrated in FIG. 11, a display color of an icon button at a time at which velocity or acceleration exceeds a set allowable value is changed and displayed” (paragraph 0017).

PTL 4 describes, with regard to a display on a touch panel of a display device for an operation machine, that “an operator, only by viewing the touch panel 5, is able to confirm a state (a selectable state (FIG. 2) or a non-selectable state (FIGS. 3 to 5)) of a desired soft button. At the same time, when a desired soft button is in the non-selectable state (FIGS. 3 to 5), the operator is able to confirm an operation condition that needs to be satisfied to switch the soft button to the selectable state (FIG. 2) by viewing an operation condition icon” (paragraph 0034).

PTL 5 describes, with regard to a tree structure display method of a document structure, that “as illustrated in FIG. 6, as an icon in a page for which annotation data, variable print data, and the like are not set, an icon 61 that indicates such a page is employed as an example. In addition, it is configured such that a page for which annotation data or variable print data are set, by adding a pencil mark to an icon in a page for which annotation data or variable print data are not set, can be clearly discriminated from the page that does not include annotation data and variable print data, as illustrated by 71 and 72 in FIG. 7.

### CITATION LIST

### Patent Literature

[PTL 1] PCT International Publication No. WO2020/012558A1

[PTL 2] Japanese Unexamined Patent Application Publication (Kokai) No. 2018-058117A

[PTL 3] Japanese Unexamined Patent Application Publication (Kokai) No. 2004-174662A

[PTL 4] PCT International Publication No. WO2015/136671A1

[PTL 5] Japanese Unexamined Patent Application Publication (Kokai) No. 2004-252725A

### SUMMARY

### Technical Problem

A scenario for consideration is one in which generation or execution of the control program is performed on a teaching device that enables programming using icons representing functions constituting a control program of a robot. A user arranges an icon in a program creation screen, sets parameters of the function that the icon represents as needed, and thereby performs programming. In such a scenario, the user wishes to immediately learn whether or not an icon can execute an expected operation or whether or not the icon has executed the expected operation. It is therefore an object of the present invention to provide a technique which enables the user performing programming using icons on a teaching device to immediately learn whether or not an icon can execute an expected operation or whether or not the icon has executed the expected operation.

### Solution to Problem

One aspect of the present disclosure is a teaching device for performing program generation using an icon representing a function constituting a control program of an industrial machine and includes a state information acquisition unit configured to acquire state information indicating whether or not an icon constituting the control program can execute an expected operation or whether or not the icon has executed the expected operation, and an information display generation unit configured to generate, based on the state information, a display relating to the icon in such a way that whether or not the icon can execute an expected operation or whether or not the icon has executed the expected operation can be visually recognized in a program creation screen.

### Advantageous Effects of Invention

The above-described configuration enables a user to instantly visually grasp whether or not an icon can execute an expected operation or whether or not the icon has executed the expected operation.

The object, characteristics, and advantages of the present invention as well as other objects, characteristics, and advantages will be further clarified from the detailed description of typical embodiments of the present invention illustrated in the accompanying drawings.

### BRIEF DESCRIPTION OF DRAWINGS

FIG. 1 is a diagram illustrating an overall configuration of a robot system including a teaching device according to a first embodiment.

FIG. 2 is a diagram illustrating a hardware configuration example of a robot controller and a teach pendant.

FIG. 3 is a functional block diagram illustrating a functional configuration of the teaching device.

FIG. 4 is a diagram illustrating a program creation screen that is displayed on a display unit of the teach pendant.

FIG. 5 is a diagram illustrating an example in which a mark (auxiliary icon) indicating an occurrence of an alarm or error is displayed on a view icon in a program constituted by icons arranged in a program creation region.

FIG. 6 is a diagram illustrating a state in which a pop-up screen indicating details of the alarm or error is displayed by selecting the view icon.

FIG. 7 is a diagram illustrating another example of a screen indicating the details of the alarm or error displayed by selecting the view icon.

FIG. 8 is a diagram illustrating a state in which a mark indicating an occurrence of an alarm or error is displayed on a call icon in a program constituted by icons arranged in the program creation region.

FIG. 9 is a diagram illustrating a state in which a pop-up screen indicating details of the alarm or error is displayed by selecting the call icon.

FIG. 10 is a diagram illustrating another example of a screen indicating the details of the alarm or error displayed by selecting the call icon.

FIG. 11 is a diagram illustrating an example of a parameter setting screen displayed by selecting an open button.

FIG. 12 is a diagram illustrating an example of a program creation screen that further includes a preview screen of a robot and is displayed on a display unit by a teaching device according to a second embodiment.

FIG. 13 is a flowchart illustrating state display processing of an icon performed by the teaching device according to the second embodiment.

FIG. 14A is a diagram illustrating an example in which a camera icon indicating a success state as an execution result of an icon is displayed in a preview screen.

FIG. 14B is a diagram illustrating an example in which a camera icon indicating a failure state as an execution result of the icon is displayed in the preview screen.

FIG. 15A is a diagram illustrating an example in which a camera icon indicating a success state as an execution result of an icon is displayed in a program creation region.

FIG. 15B is a diagram illustrating an example in which a camera icon indicating a failure state as an execution result of the icon is displayed in the program creation region.

FIG. 16 is a diagram illustrating a device configuration of a robot system including a teaching device according to a third embodiment.

FIG. 17 is a functional block diagram of the teaching device according to the third embodiment.

FIG. 18 is a flowchart illustrating determination processing to determine whether or not an auxiliary icon is to be given to a function icon.

FIG. 19 is a diagram illustrating an example in which when there is an item that has not been set in an icon arranged in a program creation region, an auxiliary icon is added to the icon.

FIG. 20 is a diagram illustrating a state in which by performing an operation of selecting a view icon in the program creation region in FIG. 19, a parameter setting screen of the view icon is displayed.

FIG. 21 is a diagram illustrating an example in which when there is an item the setting of which needs to be changed in an icon arranged in the program creation region, an auxiliary icon is added to the icon.

FIG. 22 is a diagram illustrating a state in which by performing an operation of selecting the view icon in the program creation region in FIG. 21, a parameter setting screen of the view icon is displayed.

### DESCRIPTION OF EMBODIMENTS

Embodiments of the present disclosure will be described below with reference to the accompanying drawings. In the drawings that are referred to, the same constituent components or functional components are given the same reference signs. To facilitate understanding, scales are appropriately changed in the drawings. In addition, modes illustrated in the drawings are only examples embodying the present invention, which is not limited to the illustrated modes.

Hereinafter, a teaching device that enables programming using icons representing functions constituting a control program of a robot will be described. The teaching device is configured to include a state information acquisition unit that acquires state information indicating whether or not an icon constituting the control program can execute an expected operation or whether or not the icon has executed the expected operation and an information display generation unit that generates a display relating to an icon, based on state information in such a way that whether or not the icon can execute an expected operation or whether or not the icon has executed the expected operation can be visually recognized in a program creation screen. Such a configuration enables a user to instantly visually grasp whether or not an icon can execute an expected operation or whether or not the icon has executed the expected operation in a generation step or an execution step of the control program.

### First Embodiment

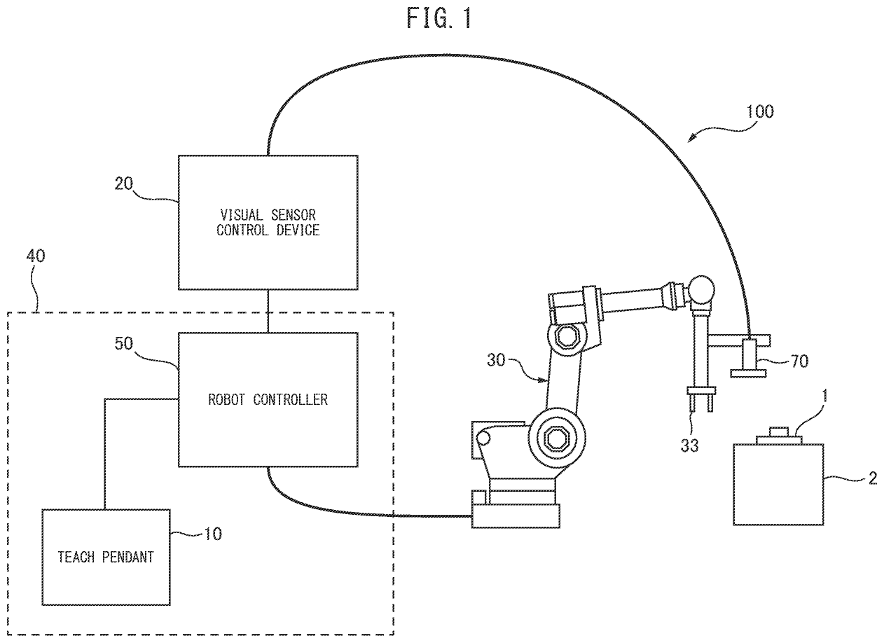

FIG. 1 is a diagram illustrating an overall configuration of a robot system 100 including a teaching device 40 according to a first embodiment. In the present embodiment, a robot controller 50 and a teach pendant 10 constitute the teaching device 40 for teaching positions and postures to a robot 30. The teaching device 40 is a teaching device that enables programming using icons representing functions constituting a control program of the robot 30 (i.e., representing instructions of robot control).

When an abnormality in operation occurs during program generation or execution of a control program using icons, the user desires to be able to immediately confirm an occurrence location of the abnormality and, furthermore, details of the abnormality. The teaching device 40 according to the present embodiment is configured to acquire information about an alarm or error occurring in association with execution of an icon by a processor as state information indicating an abnormality in operation of the icon and perform change in a display form of the icon or addition of an image to the icon.

While various configuration examples can be conceived as a robot system including the teaching device 40 as described above, the robot system 100 illustrated in FIG. 1 will be described as an example in the present embodiment. The robot system 100 includes the robot 30 on the arm tip portion of which a hand 33 is mounted, the robot controller 50 that controls the robot 30, the teach pendant 10 that is connected to the robot controller 50, a visual sensor 70 that is attached to the arm tip portion of the robot 30, and a visual sensor control device 20 that controls the visual sensor 70. The robot system 100 is capable of performing detection of a target object 1 on a work table 2, using the visual sensor 70 and performing handling of the target object 1, using the hand 33 mounted on the robot 30.

The visual sensor control device 20 has a function of controlling the visual sensor 70 and a function of performing image processing on an image captured by the visual sensor 70. The visual sensor control device 20 detects a position of the target object 1 from an image captured by the visual sensor 70 and provides the robot controller 50 with the detected position of the target object 1. Because of this configuration, the robot controller 50 is able to correct a teaching position and execute a picking-up operation of the target object 1. The visual sensor 70 may be a camera that captures a grayscale image or a color image or a stereo camera or a three-dimensional sensor that is capable of acquiring a distance image or a three-dimensional point group. A plurality of visual sensors may be arranged in the robot system 100. The visual sensor control device 20 keeps model patterns of target objects and executes image processing of detecting a target object by matching between an image of the target object in a captured image and a model pattern.

It should be noted that as an example of processing using a visual sensor, another example such as determination is applicable, in addition to the detection described herein. Although in FIG. 1, the visual sensor control device 20 is formed as a separate device from the robot controller 50, functions as the visual sensor control device 20 may be implemented in the robot controller 50.

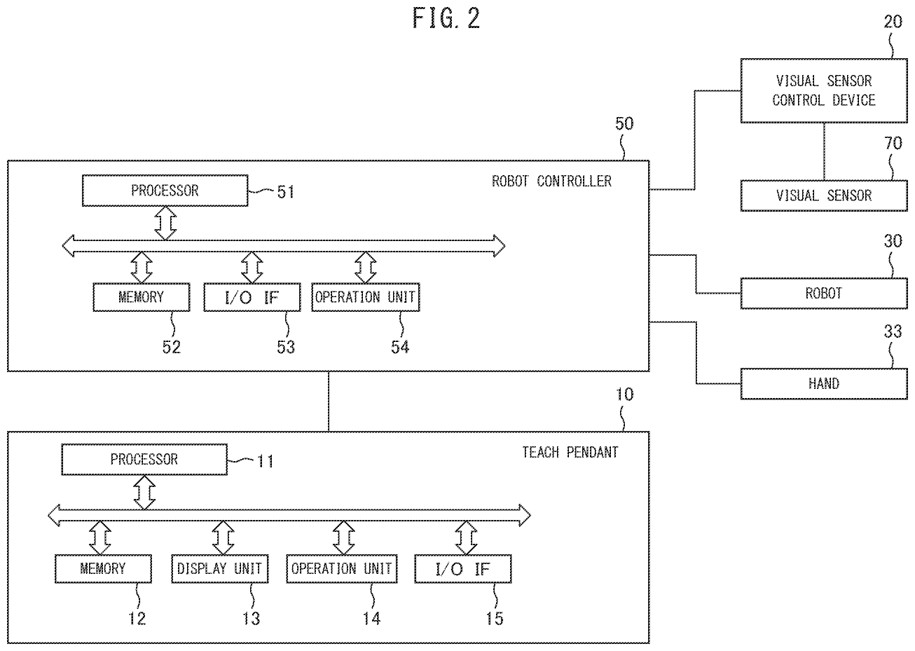

FIG. 2 is a diagram illustrating a hardware configuration example of the robot controller 50 and the teach pendant 10. The robot controller 50 may have a configuration as a general computer in which a memory 52 (a ROM, a RAM, a non-volatile memory, and the like), an input/output interface 53, an operation unit 54 including various types of switches, and the like are connected to a processor 51 via a bus. The teach pendant 10 is used as a device to perform operation input and screen display to teach the robot 30 (i.e., to generate a control program). The teach pendant 10 may have a configuration as a general computer in which a memory 12 (a ROM, a RAM, a non-volatile memory, and the like), a display unit 13, an operation unit 14 that is formed by an input device, such as a keyboard (or software keys), an input/output interface 15, and the like are connected to a processor 11 via a bus. It should be noted that in place of the teach pendant 10, various types of information processing devices, such as a tablet terminal, a smartphone, and a personal computer, may be used.

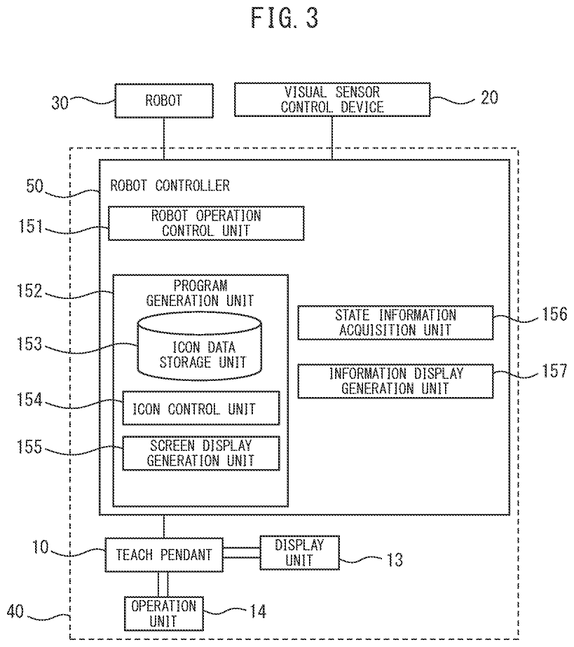

FIG. 3 is a functional block diagram illustrating a functional configuration of the teaching device 40 that is formed by the robot controller 50 and the teach pendant 10. As illustrated in FIG. 3, the robot controller 50 includes a robot operation control unit 151, a program generation unit 152, a state information acquisition unit 156, and an information display generation unit 157.

The robot operation control unit 151 controls operation of the robot 30 in accordance with the control program or commands from the teach pendant.

The program generation unit 152 provides various types of functions for the user to perform programming using icons, via a user interface (the display unit 13 and the operation unit 14) of the teach pendant 10. The program generation unit 152 includes, as constituent elements providing such functions, an icon data storage unit 153, an icon control unit 154, and a screen display generation unit 155.

The icon data storage unit 153 stores various types of information relating to icons, such as data of a shape (image) and setting parameters of each of the icons. The icon data storage unit 153 is formed in, for example, the non-volatile memory of the memory 52.

The screen display generation unit 155 provides functions of presenting various types of user interface screens that are used in performing programming using icons and accepting user input. The various types of user interface screens may be formed as screens in which touch operation can be performed.

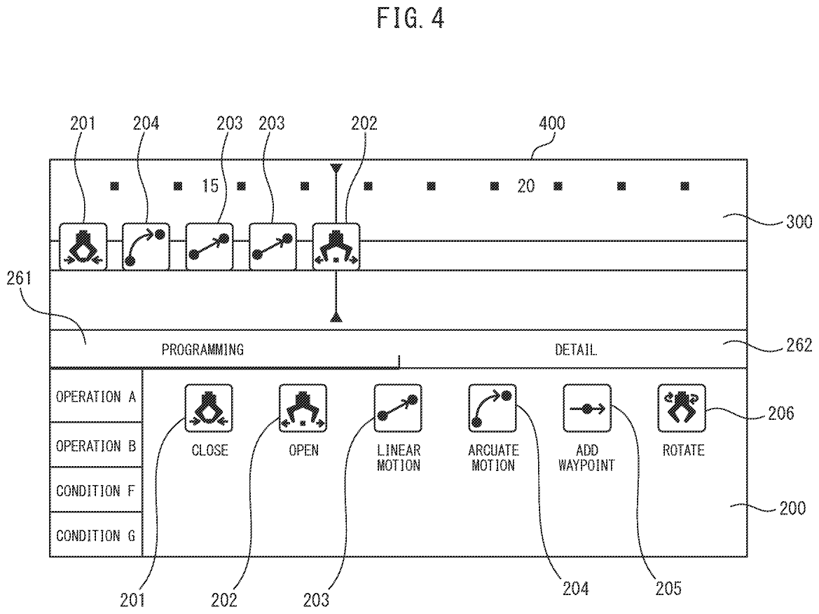

In FIG. 4, an example of a program creation screen 400 that is generated by the screen display generation unit 155 and is displayed on the display unit 13 of the teach pendant 10 is illustrated. As illustrated in FIG. 4, the program creation screen 400 includes an icon display region 200 in which a list of various types of icons that can be used in programming is displayed and a program creation region 300 in which icons are sequentially arranged and that is for creating a control program. It should be noted that since the program creation region 300 is a region in which icons are arranged in a chronological order of execution, the program creation region 300 is sometimes referred to as a timeline. In the example in FIG. 4, in the icon display region 200, a hand close icon 201 that represents an instruction to close the hand, a hand open icon 202 that represents an instruction to open the hand, a linear motion icon 203, an arcuate motion icon 204, a waypoint addition icon 205, and a rotation icon 206 that causes the hand to rotate are included.

The user is able to select an icon by, for example, pointing a cursor at the icon. The user performs programming by, for example, selecting a desired icon from the icon display region 200 and arranging the selected icon in the program creation region 300 through a drag-and-drop operation.

When the user performs programming, the user selects a programming tab 261 in the program creation screen 400. The user, by selecting an icon and selecting a detail tab 262 in the program creation region 300, is able to open a parameter setting screen to perform detail setting (parameter setting) of the icon. The user is also able to execute the control program by performing a predetermined operation while arranging icons in the program creation region 300.

The icon control unit 154 controls user operation when the user operates the operation unit 14 of the teach pendant 10 and thereby performs various types of operations on icons, tabs, and the like in the program creation screen 400. Under the assistance of the icon control unit 154, the user is able to create a control program by successively selecting desired icons from the list of icons arranged in the icon display region 200 and arranging the selected icons in the program creation region 300.

Execution of the control program is performed under the control of the robot operation control unit 151.

The state information acquisition unit 156 acquires state information indicating an abnormality in operation of an icon constituting the control program. More specifically, in the present embodiment, the state information acquisition unit 156 acquires information relating to an alarm or error with respect to an icon when the control program is executed. The information relating to an alarm or error can be acquired by monitoring an execution state of the control program in cooperation with the robot operation control unit 151 (and the visual sensor control device 20) that controls the execution of the control program.

The information display generation unit 157 generates, with respect to an icon the state information of which is acquired, a display relating to the icon in such a way that an abnormality in operation can be visually recognized. In other words, when an alarm or error occurs with respect to an icon constituting the control program, the information display generation unit 157 generates a display relating to the icon in such a way that an alarm or error having occurred with respect to the icon can be visually recognized. The information display generation unit 157 may be configured to further display at least one of details of an alarm or error, guide information to eliminate the alarm or error, and a selection button to transition to a parameter setting screen to eliminate the alarm or error. As an example, examples of a form in which the information display generation unit 157 generates a display that enables an icon with respect to which an alarm or error has occurred to be visually recognized include the following forms:
(1) adding an image of a specific mark to the icon; and
(2) changing a display form of the icon (changing color, highlighting the icon, or the like).

Examples of performing a display in such a manner as to enable an occurrence of an alarm or error to be visually recognized with respect to an icon will be described below.

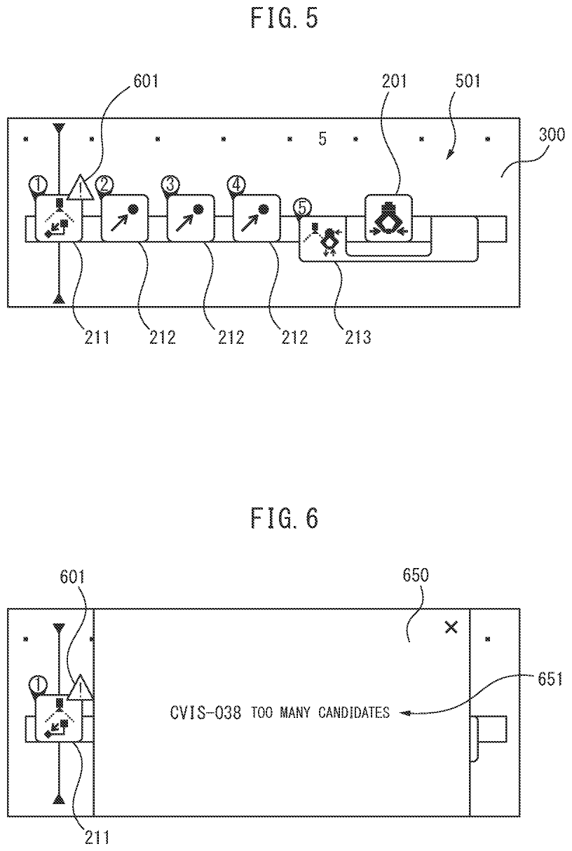

A first example of addition of a specific mark to an icon with respect to which an alarm or error has occurred will be described with reference to FIGS. 5 to 7. FIG. 5 illustrates a program 501 formed by icons arranged in the program creation region 300. The program 501 includes a view icon 211, three linear motion icons 212, a pickup/arrange icon 213, and a hand close icon 201. The view icon 211 corresponds to a visual detection function (a function of detecting a position of a target object by the visual sensor 70). The linear motion icon 212 corresponds to a function of causing the robot to move. The pickup/arrange icon 213 corresponds to a function of correcting a position of the robot (teaching position), using the position of the target object detected by the visual detection function. Including the hand close icon 201 as an internal function of the pickup/arrange icon 213 causes an operation of picking up the target object by the hand, based on the position of the target object acquired by the visual detection function to be achieved.

It is assumed that an alarm has occurred to the view icon 211 in association with execution of the program 501. In this case, the information display generation unit 157 adds a mark 601 (an auxiliary icon with “!” mark, herein) that draws attention of the user to the view icon 211 that has caused the alarm to occur. Since the mark 601 drawing attention is added to an icon displayed in the program creation region 300 (timeline), the user is able to immediately visually recognize on which icon an alarm or error has occurred among the icons constituting the program 501.

In the display state in FIG. 5, the user is able to cause details of an alarm or error having occurred to the view icon 211 to be displayed by performing a predetermined operation. The predetermined operation is, for example, an operation of selecting the icon, an operation of tapping an arbitrary position in the program creation region 300, or the like. The operation of selecting an icon may be an operation of pointing a cursor at the icon, an operation of touching the icon, or the like. FIG. 6 illustrates a state in which the user selecting the view icon 211 in the display state in FIG. 5 has caused a pop-up screen 650 indicating details of the alarm to be displayed. The pop-up screen 650 includes, as details of the alarm, code “CVIS-038” of the alarm and a message 651 (“too many candidates”) that indicates details of the alarm. It should be noted that the message “too many candidates” in the message 651 indicates that in an image captured by the visual sensor 70, the number of candidates of target objects detected by the visual detection function (pattern matching) is too large. Such an alarm can occur when, for example, a threshold value for a score that is a detection parameter of a target object is low.

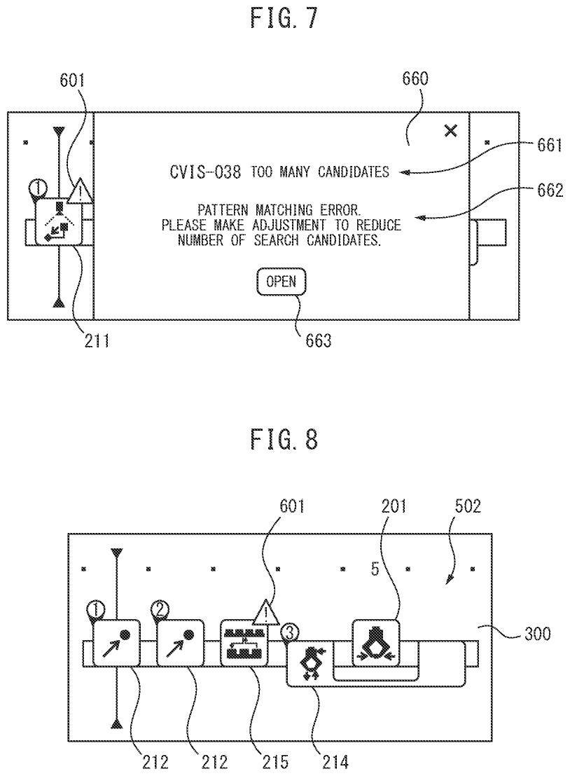

FIG. 7 illustrates a pop-up screen 660 as another example of a screen that indicates the details of the alarm or error with respect to the view icon 211 and is displayed by the user performing a predetermined operation in the display state in FIG. 5. The pop-up screen 660 includes, in addition to a message 661 that has the same content as the message 651, guide information 662 to eliminate the alarm or error. Specifically, the guide information 662 includes character information “pattern matching error” as a description of the alarm or error and a message “please make an adjustment to reduce the number of search candidates” as a guide to eliminate the alarm or error. The pop-up screen 660 further includes an open button 663 to transition to a parameter setting screen including setting items to be modified. The user is able to grasp an elimination method of the alarm or error and take a needed action by reading the guide information 662.

In addition, by selecting the open button 663, the user is able to, for example, transition to, as a parameter setting screen of the view icon 211, a screen including:
an item to teach a model used for pattern matching;
an item to set a score of the pattern matching; and
an item to set an angle of the pattern matching and a search window.

The user is able to, in such a parameter setting screen, appropriately set a score of pattern matching, taking into consideration the above-described information about an alarm or error.

In addition, an example in which the message 661 describing details of an alarm or error illustrated in FIG. 7 is replaced with a message “please readjust a model” or “please readjust a score” is conceivable.

Next, a second example of addition of a specific mark to an icon with respect to which an alarm or error has occurred will be described with reference to FIGS. 8 to 11. FIG. 8 illustrates a program 502 formed by icons arranged in the program creation region 300. The program 502 includes two linear motion icons 212, a call icon 215 to call another program, a pickup/arrange icon 214, and a hand close icon 201.

It is assumed that an alarm or error has occurred to the call icon 215 in association with execution of the program 502. In this case, the information display generation unit 157 adds the mark 601 that draws attention of the user to the call icon 215 that has caused the alarm or error to occur. Since the mark drawing attention is added to an icon displayed in the program creation region 300 (timeline), the user is able to immediately visually recognize on which icon an alarm or error has occurred among the icons constituting the program 502.

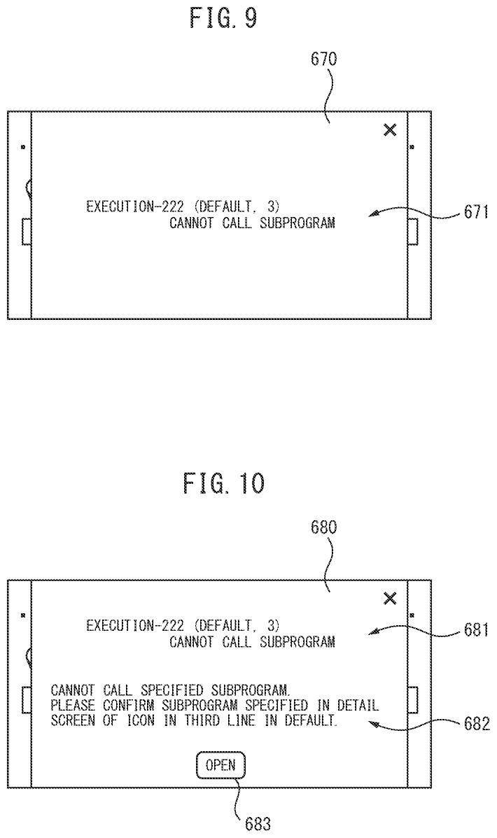

In the display state in FIG. 8, the user is able to cause details of the alarm or error having occurred on the call icon 215 to be displayed by performing a predetermined operation. FIG. 9 illustrates a state in which the user selecting the call icon 215 in the display state in FIG. 8 has caused a pop-up screen 670 indicating the details of the alarm or error to be displayed. The pop-up screen 670 includes, as a message 671 indicating the details of the alarm or error, information “execution-222” relating to a code of the alarm or error, information “DEFAULT, 3” relating to an occurrence location of the alarm or error, and information “cannot call a subprogram” indicating details of the alarm or error.

FIG. 10 illustrates a pop-up screen 680 as another example of a screen that indicates the details of the alarm or error with respect to the call icon 215 and is displayed by the user performing a predetermined operation in the display state in FIG. 8. The pop-up screen 680 includes, in addition to a message 681 that has the same content as the message 671, guide information 682 to eliminate the alarm or error. Specifically, the guide information 682 includes character information “cannot call the specified subprogram” as a description of the alarm or error and character information “please confirm a subprogram specified in the detail screen of the icon in the third line in DEFAULT” as a guide to eliminate the alarm or error. The pop-up screen 680 further includes an open button 683 to transition to a parameter setting screen including setting items to be modified. The user is able to grasp an elimination method of the alarm or error and take a needed action by reading the guide information 682.

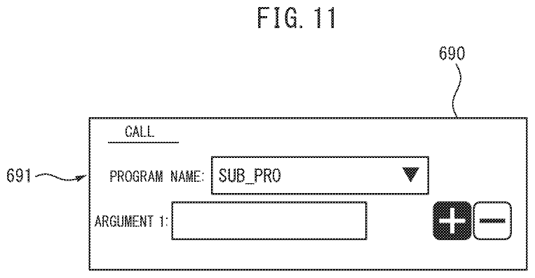

In addition, by selecting the open button 683, the user is able to transition to, for example, a parameter setting screen that serves as a parameter setting screen of the call icon 215 and includes an item to specify a subprogram. FIG. 11 illustrates a parameter setting screen 690 for the call icon 215 that is opened by selecting the open button 683 in the pop-up screen 680 illustrated in FIG. 10. The parameter setting screen 690 includes a setting item 691 to specify a subprogram name. The user is able to perform specification of an appropriate subprogram by directly writing the name of the subprogram in an input field of the setting item 691 or selecting a desired program from a list of subprograms that is displayed by selecting a menu display button. In FIG. 11, a state in which “SUB_PRO” is specified as a subprogram is illustrated. It should be noted that a display of information (alarm/error information, guide information, a parameter setting screen, and the like) relating to details of state information, based on a predetermined user operation, which was described with reference to FIGS. 6 to 7 and 9 to 11, can be achieved as a function of the information display generation unit 157.

Examples in which an icon with respect to which an alarm or error has occurred is displayed in such a manner as to be able to be visually recognized may include examples relating to various icons in addition to the above-described view icon and call icon. An example about an icon representing an operation of the robot will be described below. An icon having a function of specifying a position of the robot is referred to as a position icon. For example, when a position of the robot specified by a position icon is located out of range of movement of the robot or located at a singular point, a display (addition of an auxiliary icon, or the like) by which an alarm or error having occurred to the position icon can be visually recognized may be performed. In addition, as another example, an example in which when, in the case where two position icons (a first position icon and a second position icon) are included in the program and the robot moves from a position specified by the first position icon to a position specified by the second position icon, the robot goes out of range of movement or moves to a singular point, an image (an auxiliary icon or the like) indicating an occurrence of an alarm or error is displayed between the first position icon and the second position icon is conceivable. It should be noted that in such cases, by the user selecting a position icon with respect to which an alarm or error has occurred, information representing that the position of the robot is out of range of movement or is a singular point may be displayed by means of a pop-up screen or the like as information indicating details of the alarm or error.

As described in the foregoing, according to the first embodiment, it is possible to enable the user to immediately visually recognize an icon the operation of which is abnormal. In particular, performing a display in a method of changing a display form of or adding an image to an icon with respect to which an alarm or error has occurred in the program creation region 300 enables the user who performs programming to immediately visually recognize the icon with respect to which the alarm or error has occurred in the control program. Therefore, it becomes possible to improve convenience for a user who performs programming and enable the user to efficiently perform programming.

### Second Embodiment

Next, a second embodiment will be described. Since a teaching device according to the second embodiment can be achieved by the same configuration as the configuration described in the device configuration, the hardware configuration, and the functional block diagram of the teaching device 40 and the robot system 100 illustrated in FIGS. 1 to 3, the following description will also be made with reference to FIGS. 1 to 3 in the present embodiment.

There are some cases where, at each teaching position of a control program, a robot performs some operation, such as detection of a workpiece and picking-up of a workpiece. In such cases, such operation is sometimes accompanied by some result (success or failure of detection or success or failure of picking-up). A user desires to immediately know an execution result of such processing. In a teaching device 40 according to the present embodiment, a state information acquisition unit 156 acquires state information indicating an execution result with respect to an icon constituting a control program. Such information can be acquired by the state information acquisition unit 156 monitoring an operation result of the control program in cooperation with a robot operation control unit 151 (and a visual sensor control device 20) that controls operation of the control program. An information display generation unit 157 generates a display relating to an icon the state information of which is acquired in such a way that with respect to the icon, an execution result can be visually recognized.

In the present embodiment, the information display generation unit 157 performs a display relating to an execution result of an icon in a program creation region and/or a model image display screen (hereinafter, also referred to as a preview screen) in which operation of the robot that operates in accordance with the execution of the control program is displayed by movement of a 3D robot model.

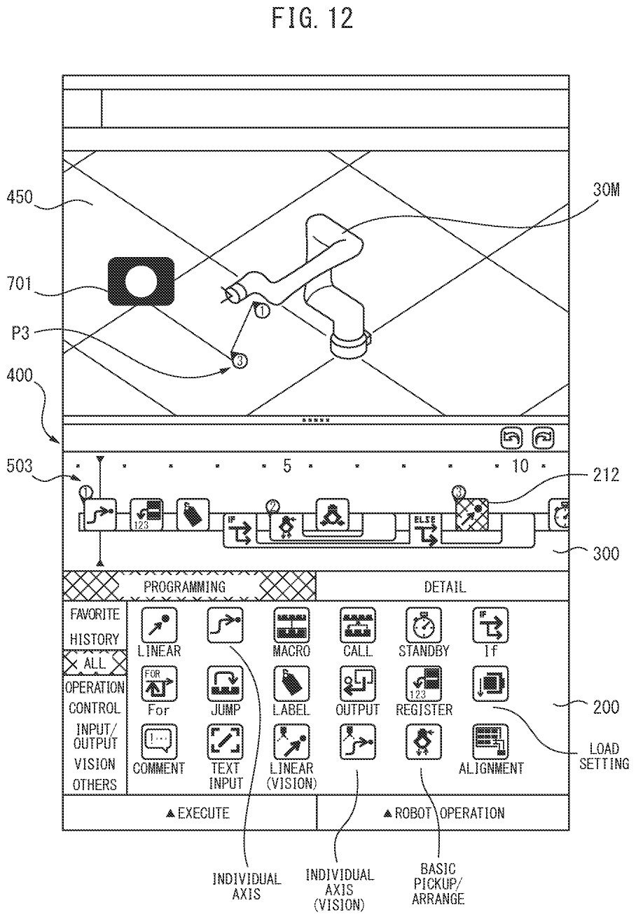

FIG. 12 illustrates a program creation screen 400 that is displayed on a display unit 13 by the teaching device 40 according to the present embodiment. The program creation screen 400 includes a preview screen 450 in which a robot model 30M that is a 3D model of the robot 30 is displayed. As illustrated in FIG. 12, the program creation screen 400 includes an icon display region 200, a program creation region 300, and the preview screen 450. When a control program formed by icons arranged in the program creation region 300 is executed, the robot model 30M arranged in the preview screen 450 operates following movement of the robot 30.

A function of causing the robot model 30M to operate following the movement of the robot 30 in the preview screen 450 may be achieved as a function of a screen display generation unit 155. In this case, the screen display generation unit 155 acquires information relating to the movement of the robot 30 by cooperating with the robot operation control unit 151.

In FIG. 12, a program 503 created in the program creation region 300 includes an individual axis motion icon, a register icon to set a value in a register, a label icon to perform specification of a label number, a conditional branch icon corresponding to a conditional branch instruction, a pickup/arrange icon, a hand close icon, and a linear motion icon 212. A position P3 represented by numeral 3 surrounded by a circle in the preview screen 450 corresponds to a teaching position that is set in the linear motion icon 212. It is assumed herein that a numeral surrounded by a circle displayed in the program creation region 300 and the preview screen 450 indicates a number of a teaching position. In the program 503, a third teaching position is set in the linear motion icon 212.

In the present embodiment, the teaching device 40 (the information display generation unit 157) provides functions (A1) to (A3) of performing a display as described below with respect to an execution result of an icon in the program creation screen 400.
(A1) When the teaching device 40 displays a teaching position specified by the user as a 3D graphic in the preview screen 450, the teaching device 40 displays an icon that enables what processing (operation) is to be performed at the teaching position to be visually grasped. A case where a visual detection program (visual detection function) is included in the linear motion icon 212 as a command is now assumed. In this case, since image capturing and detection by the visual detection function is performed at the teaching position P3 of the linear motion icon 212, a camera icon 701 representing a camera is associated with the teaching position P3. This configuration enables the user to instantly intuitively grasp what processing is to be performed at each teaching position.
(A2) The teaching device 40 performs a display that enables whether or not processing at a teaching position succeeded to be visually grasped, after the execution of the control program. Examples of a method of display in this case may include the following examples.
   (A-2-1) In the preview screen 450, when processing of an icon succeeded, the camera icon is represented by a specific color (for example, green), and when the processing of the icon failed, the camera icon is represented by a color (for example, red) different from the specific color.
   (A-2-2) According to a detection result, a display form of an icon (linear motion icon 212) that is arranged in the program creation region 300 and corresponds to the teaching position is changed or a specific mark (for example, a camera icon) is added to the icon. For example, when the processing of the icon succeeded, the mark is displayed in green, and when the processing of the icon failed, the mark is displayed in red.
   (A-2-3) The above-described (A-2-1) and (A-2-2) are used in combination.

The above-described examples enable the user to instantly intuitively grasp a result of processing performed at each teaching position.
(A3) When the icon is selected (for example, tapped) after the execution of the control program, the teaching device 40 displays information relating to an execution result in, for example, a pop-up screen. The information about the execution result is, for example, the number of detected workpieces or an image of a detected workpiece.

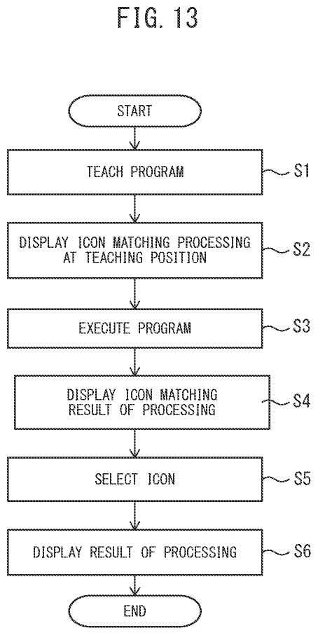

FIG. 13 is a flowchart illustrating state display processing of an icon performed by the teaching device 40 in the present embodiment. The processing is executed under the control of a processor of the teaching device 40 (in this case, a processor 51 of a robot controller 50).

First, teaching of a control program by a user is performed (step S1). In this step, programming through arrangement of icons and parameter input for setting of a teaching position in each icon and the like are accepted. Next, the teaching device 40 displays an icon matching processing (operation) at each teaching position (step S2). In this step, a display such as, as illustrated in FIG. 12, adding the camera icon 701 to the third teaching position P3 is performed.

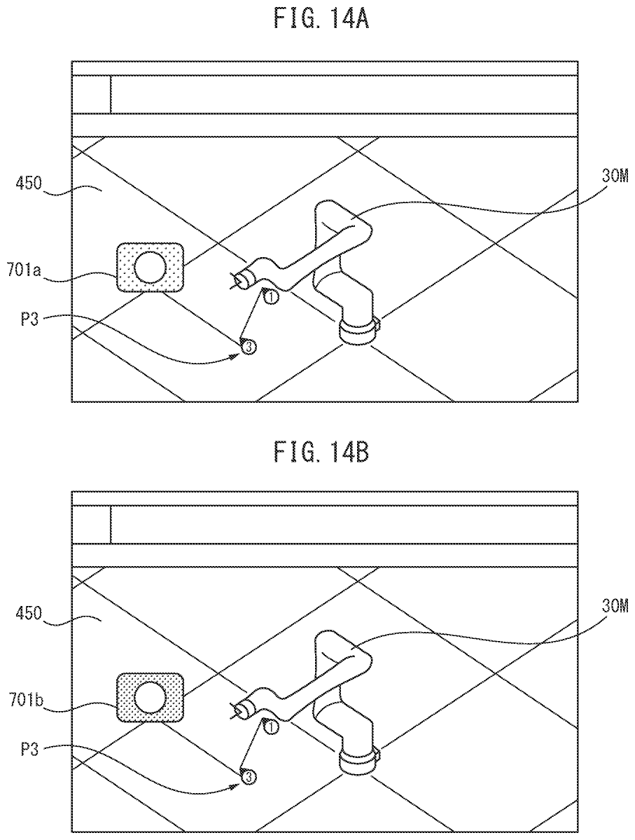

Next, a program formed by icons arranged in the program creation region 300 is executed in accordance with, for example, a predetermined operation by the user (step S3). Next, a display matching a result of the processing is performed (step S4). Herein, a display example in which the camera icon 701 displayed in a corresponding manner to the teaching position P3 is displayed with the color thereof changed will be described as an example of a display of an icon matching a result of processing. FIG. 14A illustrates a case where when a detection result of the visual detection function as processing at the teaching position P3 is a success, the camera icon 701 that is added to the teaching position P3 is displayed in a specific color (for example, green) in the preview screen 450. It should be noted that in FIG. 14A, a reference sign 701a is assigned to the camera icon to which a specific color indicating a success is added and a display form in the specific color is represented by shading.

FIG. 14B illustrates a case where in the preview screen 450, a display in which in order to represent that a detection result of the visual detection function at the teaching position P3 is a failure, the color of the camera icon 701 is set to a color different from the case of success (for example, red) is performed. It should be noted that in FIG. 14B, a reference sign 701b is assigned to the camera icon to which a specific color indicating a failure is added and a display form of the specific color is represented by shading. Because of this configuration, the user, by viewing the preview screen 450, is able to immediately visually recognize whether the execution result of the visual detection function, which is included as a function of the linear motion icon 212, is a success or failure.

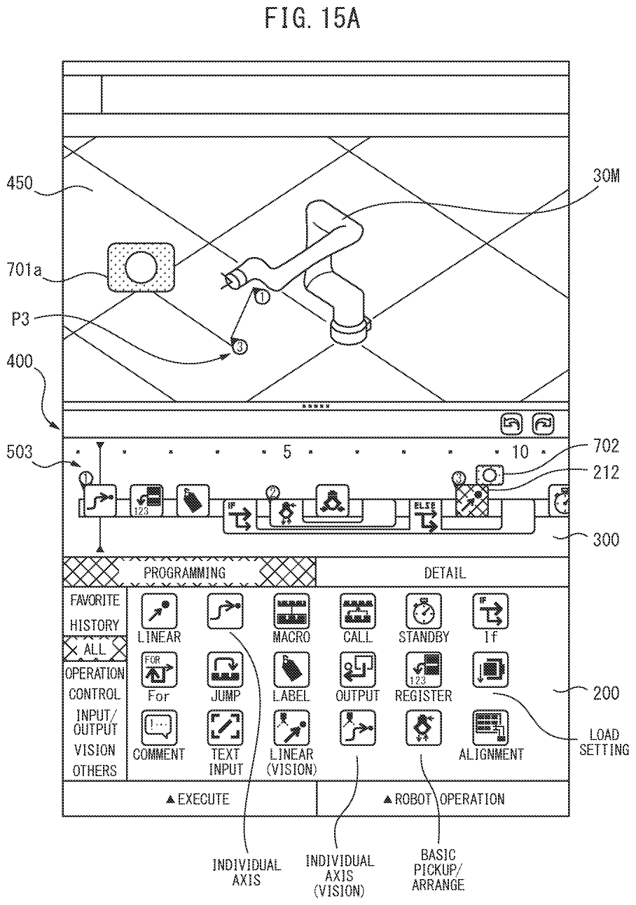

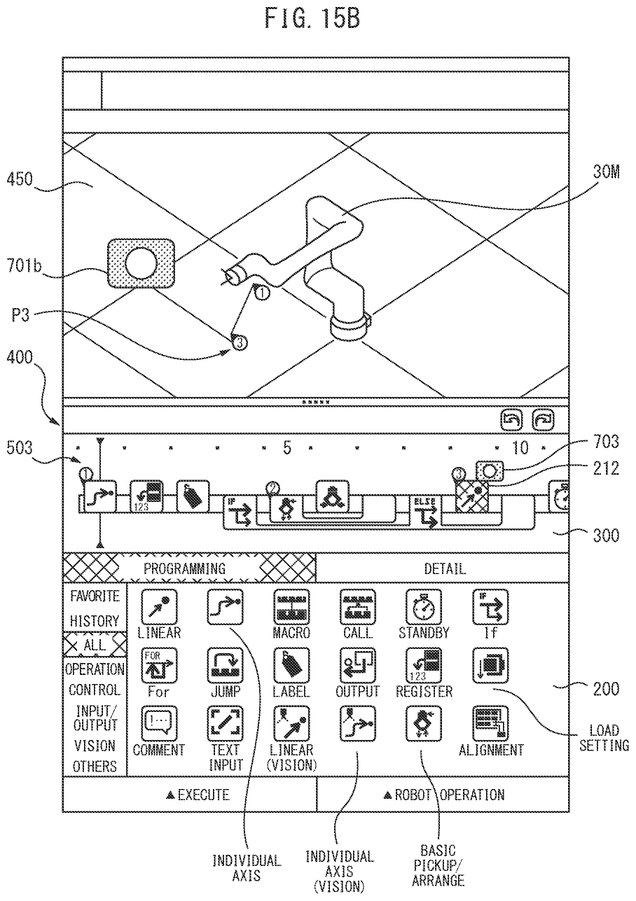

FIGS. 15A and 15B illustrate examples in which an execution result of the visual detection function is displayed in both the preview screen 450 and the program creation region 300 (timeline).

FIG. 15A is a display example when the execution result of the visual detection function executed at the teaching position P3 is a success. As illustrated in FIG. 15A, the camera icon 701a that is given a specific color indicating a success is displayed in association with the teaching position P3 in the preview screen 450. In addition, in the program creation region 300, a camera icon 702 that is given the color indicating a success is added to the linear motion icon 212 corresponding to the teaching position P3.

FIG. 15B is a display example when the execution result of the visual detection function executed at the teaching position P3 is a failure. As illustrated in FIG. 15B, the camera icon 701b that is given a specific color indicating a failure is displayed in association with the teaching position P3 in the preview screen 450. In addition, in the program creation region 300, a camera icon 703 that is given the color indicating a failure is added to the linear motion icon 212 corresponding to the teaching position P3. Because of this configuration, the user, by viewing the program creation region 300 or the preview screen 450, is able to immediately visually recognize whether the execution result of the visual detection function, which is included as a function of the linear motion icon 212, is a success or failure.

It should be noted that although, in FIGS. 15A and 15B, an example is described in which a display for recognizing an execution result of an icon is performed in both the preview screen 450 and the program creation region 300, an example in which the display for recognizing an execution result of an icon is performed only with respect to the program creation region 300 is also conceivable.

Returning to the description of FIG. 13, when the icon (the linear motion icon 212 or the camera icon 701) is selected (for example, tapped) (step S5), the teaching device 40 displays information relating to an execution result in, for example, a pop-up screen (step S6).

It should be noted that although, in the above description, an example is described in which a camera icon is displayed with the display form thereof changed in the program creation region 300 and the preview screen 450 as an operation example in which an execution result of an icon (the linear motion icon 212) including processing by a visual sensor is displayed, an operation example in which, in place of the camera icon (701a, 701b, 702, or 703), a thumbnail or a graphic in a thumbnail of a captured image as an execution result of processing by the visual sensor is displayed in the program creation region 300 or the preview screen 450 is also conceivable.

As described in the foregoing, according to the second embodiment, it is possible to enable the user to immediately visually recognize an execution result of processing of an icon. In particular, it becomes possible to immediately visually recognize an execution result of an icon in the program creation region 300. Therefore, it is possible to improve convenience for a user performing programming and thus enable the user to perform programming more efficiently.

### Third Embodiment

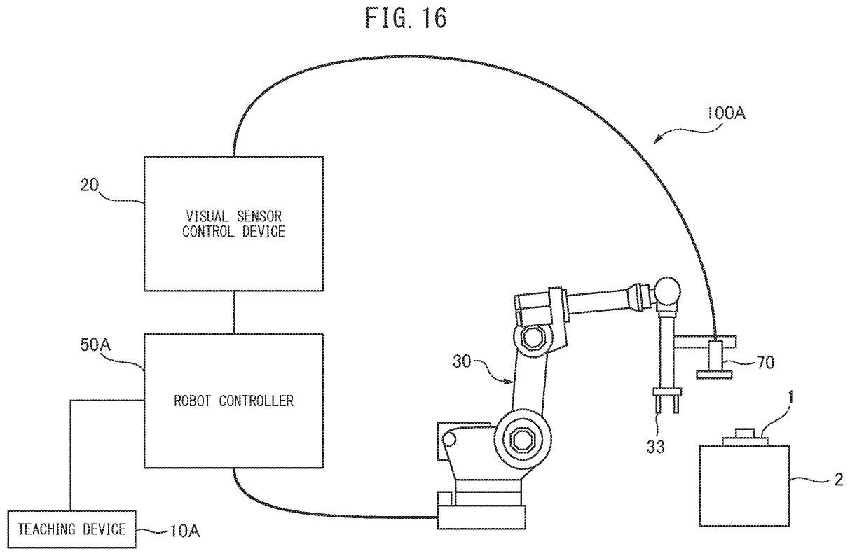

A third embodiment will be described below. FIG. 16 is a diagram illustrating a device configuration of a robot system 100A including a teaching device 10A according to the third embodiment. Since the robot system 100A has the same device configuration as the robot system 100 according to the first embodiment, the same devices as those in the robot system 100 illustrated in FIG. 1 are given the same reference signs in FIG. 16. As illustrated in FIG. 16, the robot system 100A includes a robot 30 on which a hand 33 is mounted, a robot controller 50A that controls the robot 30, a visual sensor 70, a visual sensor control device 20 that controls the visual sensor 70, and the teaching device 10A that is connected to the robot controller 50A. In the robot system 100A according to the third embodiment, the teaching device 10A is configured as a separate device connected to the robot controller 50A. The teaching device 10A can be formed by a teach pendant, a tablet terminal, a personal computer, and other various types of information processing devices.

Hardware configurations of the robot controller 50A and the teaching device 10A are the same as the hardware configurations of the robot controller 50 and the teach pendant 10 illustrated in FIG. 2, respectively.

As with the teaching device 40 according to the first embodiment, the teaching device 10A has a function as a programming device that enables generation of a control program using icons. In such a teaching device, users often desire to know whether setting of icons in a control program has been completed. When setting with respect to an icon constituting a control program is in an incomplete state, the teaching device 10A according to the present embodiment performs a display in such a manner that setting with respect to the icon being in an incomplete state can be visually recognized. Herein, examples of the setting incomplete state include a case where there is an item that has not been set and a case where there is an item the setting of which needs to be changed.

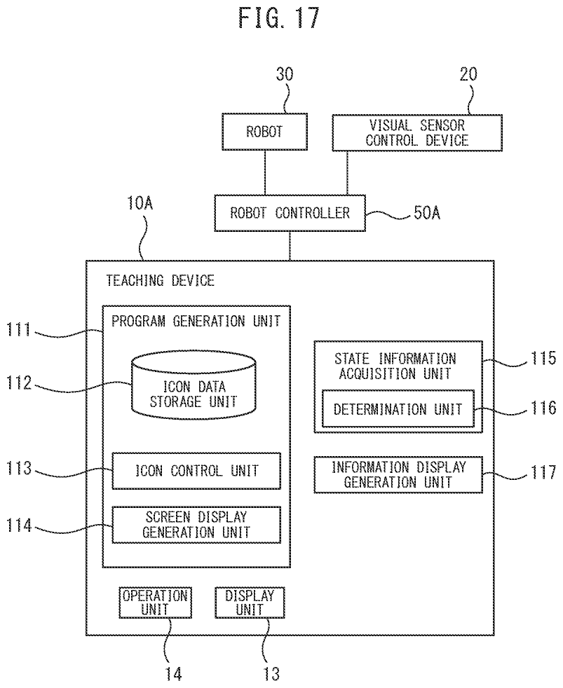

FIG. 17 is a functional block diagram of the teaching device 10A. The teaching device 10A includes a program generation unit 111, a state information acquisition unit 115, and an information display generation unit 117. The program generation unit 111 includes an icon data storage unit 112, an icon control unit 113, and a screen display generation unit 114. The program generation unit 111 has the same function as that of the program generation unit 152 in the first embodiment. In addition, the icon data storage unit 112, the icon control unit 113, and the screen display generation unit 114 have the same functions as those of the icon data storage unit 153, the icon control unit 154, and the screen display generation unit 155 in the first embodiment, respectively. In other words, the program generation unit 111 includes a function of presenting a program creation screen 400 illustrated in FIG. 4 and supporting programming using icons.

The state information acquisition unit 115 acquires state information indicating a setting incomplete state with respect to an icon constituting the control program. Such state information can be acquired from information relating to detail setting of the icon that is stored in the icon data storage unit 112. In the present embodiment, the state information acquisition unit 115 has functions of determining whether or not there exists an item that has not been set and determining whether or not there exists an item the setting of which needs to be changed with respect to an icon constituting the control program. It is assumed that a determination unit 116 is in charge of functions of performing such determination.

The information display generation unit 117 generates a display relating to an icon the state information of which is acquired in such a way that with respect to the icon, setting being in an incomplete state can be visually recognized. More specifically, the information display generation unit 117 generates, with respect to an icon that is determined to have a setting item that has not been set by the determination unit 116 or an icon that is determined to have an item the setting of which needs to be changed by the determination unit 116, a display that enables the icon to be visually recognized. It should be noted that in the present embodiment, an icon constituting a control program is sometimes referred to as a function icon.

It should be noted that examples of a method for performing a display in such a manner that an item that has not been set or an item the setting of which needs to be changed existing with respect to an icon can be visually recognized include changing a display form of the icon and adding an image to the icon. In changing a display form of an icon, performing highlighting by changing a color of the icon or the like can be included. In adding an image to an icon, adding a specific mark, icon, or the like to the icon can be included. In an operation example described below, as a method for performing a display in such a manner that an item that has not been set or an item the setting of which needs to be changed existing with respect to an icon to be determined can be visually recognized, a form in which an auxiliary icon having a specific mark is added will be described.

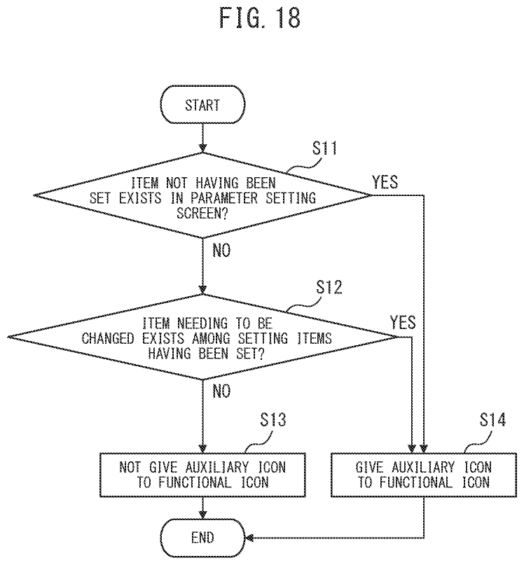

FIG. 18 is a flowchart illustrating determination processing performed by the determination unit 116 to determine whether or not an auxiliary icon is to be given to an icon (function icon). The determination processing is executed under the control of a processor of the teaching device 10A. The determination processing is executed for each of icons arranged in a program creation region 300.

First, the determination unit 116 determines whether or not an item that has not been set exists in setting items in a parameter setting screen of an icon arranged in the program creation region 300 (step S11). When an item that has not been set exists for the icon (step S11: YES), the information display generation unit 117 gives the icon an auxiliary icon to indicate that an item that has not been set exists (step S14).

When it is determined that no item that has not been set exists (step S11: NO), the determination unit 116 next determines, with respect to the icon, whether or not there is an item the setting of which needs to be changed among setting items that have already been set (step S12). When it is determined that an item the setting of which needs to be changed exists among the setting items that have already been set (step S12: YES), the information display generation unit 117 gives the icon an auxiliary icon to indicate that an item the setting of which needs to be changed exists (step S14).

When in step S12, it is determined that there is no item the setting of which needs to be changed among the setting items that have already been set (step S12: NO), i.e., when both determination results in steps S11 and S12 are NO, the information display generation unit 117 does not give the icon an auxiliary icon (step S13). Then, the determination processing terminates.

When with regard to detail setting items of an icon, there is an item that has not been set or there is a setting item the setting of which needs to be changed, the determination processing described above enables a user to immediately visually recognize the fact.

Examples of a timing at which the above-described determination processing is executed include the following cases where:
(1) the determination processing is executed when execution of a program including an icon arranged in the program creation region 300 is instructed;
(2) the determination processing is executed every time a new icon is arranged in the program creation region 300;
(3) the determination processing is executed at a timing at which parameter setting via a parameter setting screen is performed on an icon; and
(4) the determination processing is repeatedly and cyclically executed while programming is performed.

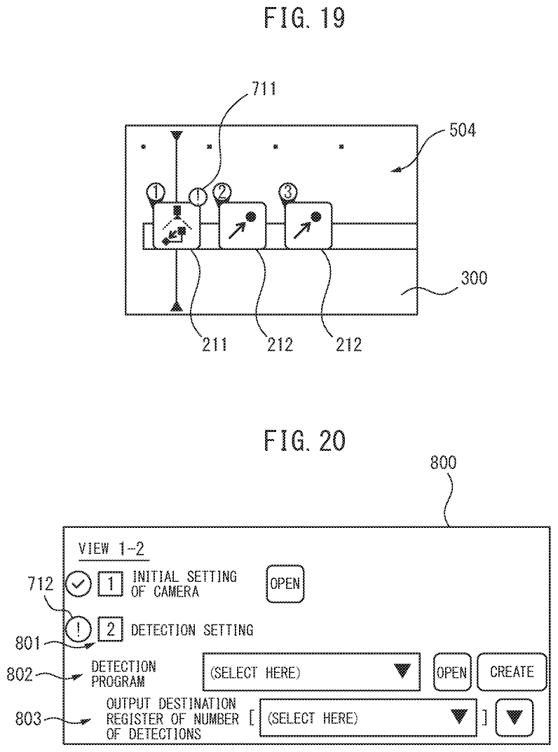

FIG. 19 illustrates an example in which when there is an item that has not been set for an icon arranged in the program creation region 300, an auxiliary icon is added to the icon. A program 504 illustrated in FIG. 19 includes a view icon 211 and two linear motion icons 212. When the user performs a predetermined operation to cause the program 504 to be executed, since there is an item that has not been set for the view icon 211, an auxiliary icon 711 to indicate that there is an item that has not been set is added to the view icon. Because of this configuration, the user is able to immediately recognize that there is an item that has not been set with respect to the view icon 211.

In order to eliminate the setting incomplete state with respect to the view icon 211, the user is able to open a parameter setting screen by selecting the view icon 211. FIG. 20 illustrates a state in which by performing an operation of selecting the view icon 211 in the program creation region 300 in FIG. 19, a parameter setting screen 800 of the view icon 211 is displayed.

As illustrated in FIG. 20, the parameter setting screen 800 includes, as setting items, an “initial setting of a camera” and a “detection setting” (reference sign 801). In the present example, specifications of a “detection program” (reference sign 802) and an “output destination register of the number of detections” (reference sign 803) in the “detection setting” (reference sign 801) have not been set. In the parameter setting screen 800, in order to indicate that the “detection setting” has not been set, an auxiliary icon 712 that draws attention of the user is added in adjacency to the item “detection setting”. The auxiliary icon 712 that is displayed in adjacency to the item “detection setting” may be the same icon as the auxiliary icon 711 added to the view icon 211 or an icon different from the auxiliary icon 711.

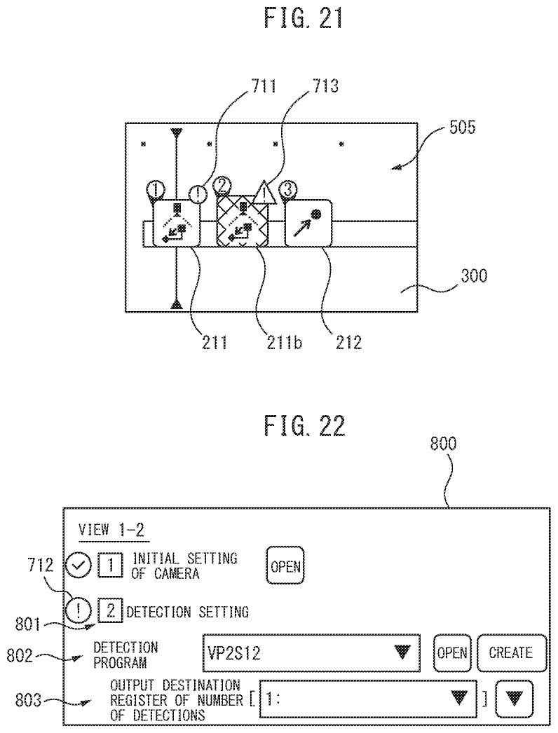

FIG. 21 illustrates an example in which when there is an item the setting of which needs to be changed for an icon arranged in the program creation region 300, an auxiliary icon is added to the icon. A program 505 illustrated in FIG. 21 includes a view icon 211, a view icon 211b, and a linear motion icon 212. When the user performs a predetermined operation to cause the program 505 to be executed, since there is an item the setting of which needs to be changed for the view icon 211b, an auxiliary icon 713 to indicate that there is an item the setting of which needs to be changed is added to the view icon 211b. It should be noted that since there is an item that has not been set for the view icon 211, the auxiliary icon 711 is added to the view icon 211. Because of this configuration, the user is able to immediately recognize that there is an item the setting of which needs to be changed with respect to the view icon 211b.

In this configuration, the auxiliary icon 713 to indicate an icon with respect to which an item the setting of which needs to be changed exists is set to an icon that has a different form from the auxiliary icon 711 added to an icon with respect to which there is an item that has not been set. Because of this configuration, even when as illustrated in FIG. 21, an icon with respect to which there is a setting item that has not been set and an icon with respect to which there is a setting item the setting of which needs to be changed coexist, it is possible to immediately visually discriminate the icon with respect to which there is a setting item that has not been set and the icon with respect to which there is a setting item the setting of which needs to be changed from each other. It should be noted that when a display method of changing a display form of an icon that is in the setting incomplete state is employed, the display form of an icon with respect to which there is an item that has not been set and the display form of an icon with respect to which there is an item the setting of which needs to be changed are also differentiated from each other.

By selecting the view icon 211b, the user is able to open a parameter setting screen of the view icon 211b. FIG. 22 illustrates a state in which by performing an operation of selecting the view icon 211b in the program creation region 300 in FIG. 21, a parameter setting screen 800 of the view icon 211b is displayed.

By a specified program name ‘VP2S12’ in the “detection program” field being displayed in a specific color (for example, red), the parameter setting screen 800 in FIG. 22 is displayed in such a way that setting change needing to be performed with respect to specification of the “detection program” in the “detection setting” can be immediately recognized. Such a situation may occur caused by, for example, the detection program ‘VP2S12’ being determined not to exist. It should be noted that display of information (a parameter setting screen and the like) relating to details of state information, based on a predetermined user operation, which was described with reference to FIGS. 20 and 22, can be achieved as a function of the information display generation unit 117.

It should be noted that although herein a view icon was described as an icon with respect to which there is an item that has not been set or an item the setting of which needs to be changed in an exemplifying manner, a case where there is an item that has not been set or an item the setting of which needs to be changed may occur to various icons including an icon relating to an operation instruction of the robot.

As an example, when in the “linear motion icon”, no value is stored in a register that specifies a position of a movement destination, it can be determined that there is an item that has not been set. In this case, the information display generation unit 117 adds the above-described auxiliary icon 711 to the “linear motion icon” that is arranged in the program creation region 300.

As another example, there can be a case where an item the setting of which needs to be changed occurs with respect to an icon to be determined in relation to icons existing in front and in the rear thereof. For example, an “image capture icon” that instructs image capturing using a camera and a “view and pickup icon” that, using a result of detection of a target object by the image capture icon, performs picking-up of a workpiece are considered. Generally, an “image capture icon” and a “view and pickup icon” are sequentially arranged side by side. However, when details of the “image capture icon” are changed due to some reason, the “view and pickup icon” can be brought into a state in which no effective value is stored in a position register in the “view and pickup icon”. In this case, the determination unit 116, by confirming setting information of the icons, is capable of determining that there exists an item the setting of which needs to be changed among setting items of the “view and pickup icon”. In this case, the information display generation unit 117 adds the above-described auxiliary icon 713 to the “view and pickup icon” that is arranged in the program creation region 300.

The teaching device 10A may be further configured to perform a display in such a way that with respect to an icon with respect to which setting of all setting items is completed, the setting having been completed can be visually recognized. In other words, in this case, the state information acquisition unit 115 (determination unit 116) determines whether or not the setting of the icon is appropriately completed based on information relating to a setting state of the icon. For example, the information display generation unit 117 may add an auxiliary icon indicating a setting completion state (various types of marks, characters, or the like that can represent a completion state) to an icon with respect to which setting is completed, in the program creation region 300.

The display examples that were described with reference to FIGS. 19 and 20 are display examples when one auxiliary icon is added to an icon that has a setting item that has not been set. In place of such display examples, when an icon has items that have not been set, the information display generation unit 117 may add a display that enables the number of items that have not been set to be recognized to the icon. For example, a method of adding, to an icon that has items that have not been set, auxiliary icons (“!” marks) the number of which is the same as the number of the items that have not been set or adding an auxiliary icon that displays the number of the items that have not been set is conceivable. Likewise, in the case of an icon that has items the settings of which need to be changed, which was described with reference to FIGS. 21 and 22, a method of adding an auxiliary icon to the icon in such a way that the number of the items the settings of which need to be changed can be recognized is also conceivable. With regard to an icon with respect to which setting items that have not been set and setting items the settings of which need to be changed coexist, it may be configured to add both an auxiliary icon indicating existence (the number) of items that have not been set and an auxiliary icon indicating existence (the number) of items the settings of which need to be changed.

As described in the foregoing, according to the third embodiment, it is possible to enable the user to immediately visually recognize that setting of an icon is in a complete state or an incomplete state. In particular, it becomes possible to immediately visually recognize a setting complete state or a setting incomplete state of an icon in the program creation region 300. Therefore, it becomes possible to improve convenience for a user who performs programming and enable the user to efficiently perform programming.

The configurations of the respective embodiments described above enable a user to instantly visually grasp whether or not an icon can execute an expected operation or whether or not the icon has executed the expected operation in a generation step or an execution step of a control program.

Although the present invention was described above using typical embodiments, a person skilled in the art would understand that changes and other various modifications, omissions, and additions can be made to the embodiments described above without departing from the scope of the present invention.

The configurations described in the above-described embodiments are applicable to not only a robot system but also a system that includes a programming device to generate programs for various industrial machines.

In the above-described second embodiment, an example in which information representing an execution result of a function that an icon has is displayed in the preview screen was described. A teaching device that executes such a function can, for example, be described as follows.

A teaching device for performing program generation using an icon representing a function constituting a control program of an industrial machine, the teaching device including:
a state information acquisition unit that acquires information relating to an execution result with respect to the icon constituting the control program; and
an information display generation unit that displays information relating to the execution result in a screen in which a 3D model of the industrial machine that operates in accordance with the control program is displayed.

Because of this configuration, a user is able to instantly grasp what processing is performed at each teaching position and whether or not processing at each teaching position has succeeded or failed in a screen in which a 3D model of a robot is displayed. The user is also able to immediately acquire detailed information relating to a result of processing at the teaching position. Therefore, convenience for a user who performs programming is improved.

In the above-described configuration, the information display generation unit may perform a display that represents an execution result of a function of the icon in association with a position corresponding to a position at which the function of the icon is executed, in a screen in which a 3D model is displayed. In this case, the position at which the function of the icon is executed is, for example, a teaching position that is taught as a setting of the icon. The display that represents an execution result is, for example, a display that is achieved by changing a display form of a mark indicating the function of the icon according to the execution result.

Although in the above-described embodiments, it was described that the program creation region and the model image display screen were a region and a screen that were configured integrally with the program creation screen, the region and screen may be a region and a screen that are presented as separate screens from the program creation region.

The arrangement of functional blocks as a teaching device illustrated in FIG. 3 or FIG. 17 is an example and it is needless to say that the teaching device is not limited to such a configuration. For example, in the configuration of the teaching device 40 illustrated in FIG. 3, a configuration in which at least some of the functions arranged on the robot controller 50 side are arranged on the teach pendant 10 side is conceivable.

The functional blocks in the functional block diagram of the teaching device illustrated in FIG. 3 or FIG. 17 may be achieved by a processor of a device (the robot controller 50 or the teaching device 10A) constituting the teaching device executing various types of software stored in the storage device or may be achieved by a configuration in which hardware, such as an application specific integrated circuit (ASIC), is mainly used.

Various types of programs that are executed in the teaching device including the state display processing of an icon illustrated in FIG. 13, the determination processing of an icon illustrated in FIG. 18, and the like can be recorded in various types of computer-readable recording media (for example, a semiconductor memory, such as a ROM, an EEPROM, and a flash memory, a magnetic recording medium, and an optical disk, such as a CD-ROM, a DVD, and a DVD-ROM).

### REFERENCE SIGNS LIST

1 Target object
2 Work table
10 Teach pendant
11 Processor
12 Memory
13 Display unit
14 Operation unit
15 Input/output interface
20 Visual sensor control device
30 Robot
30M Robot model
33 Hand
40 Teaching device
50 Robot controller
51 Processor
52 Memory
53 Input/output interface
54 Operation unit
70 Visual sensor
100 Robot system
111 Program generation unit
112 Icon data storage unit
113 Icon control unit
114 Screen display generation unit
115 State information acquisition unit
116 Determination unit
117 Information display generation unit
151 Robot operation control unit
152 Program generation unit
153 Icon data storage unit
154 Icon control unit
155 Screen display generation unit
156 State information acquisition unit
157 Information display generation unit
200 Icon display region
261 Programming tab
262 Detail tab
300 Program creation region
400 Program creation screen
450 Preview screen
501, 502, 503, 504, 505 Program
601 Mark
650, 660, 670, 680 Pop-up screen
663, 683 Open button
690 Parameter setting screen
701, 701a, 701b, 702 Camera icon
711, 713 Auxiliary icon
800 Parameter setting screen

1. A teaching device for performing program generation using an icon representing a function constituting a control program of an industrial machine, the teaching device comprising:
a state information acquisition unit configured to acquire state information indicating whether or not an icon constituting the control program can execute an expected operation or whether or not the icon has executed the expected operation; and
an information display generation unit configured to generate, based on the state information, a display relating to the icon in such a way that whether or not the icon can execute an expected operation or whether or not the icon has executed the expected operation can be visually recognized in a program creation screen.

2. The teaching device according to claim 1, wherein
the state information acquisition unit acquires, as the state information, information indicating at least one of a setting complete state or a setting incomplete state, an abnormality in operation, and an execution result with respect to an icon constituting the control program, and
the information display generation unit generates a display relating to the icon in such a way that with respect to the icon the state information of which is acquired, the setting being in a complete state or an incomplete state, an abnormality having occurred in the operation, or the execution result can be visually recognized.

3. The teaching device according to claim 1, wherein the information display generation unit generates a display relating to the icon by performing a change of a display form of the icon or addition of an image to the icon.

4. The teaching device according to claim 1, wherein the information display generation unit displays information relating to details of the state information in a display screen in response to a predetermined operation via an operation unit.

5. The teaching device according to claim 1, wherein the state information is information of an alarm or error that occurs in association with execution of the icon.

6. The teaching device according to claim 5, wherein the information display generation unit adds an image representing a specific mark to the icon with respect to which the alarm or error has occurred.

7. The teaching device according to claim 5, wherein the information display generation unit further generates a display of at least one of details of the alarm or error, guide information to eliminate the alarm or error, and a selection button to transition to a parameter setting screen to eliminate the alarm or error.

8. The teaching device according to claim 5, wherein
as an icon constituting the control program, a position icon having a function of specifying a position of the industrial machine is included, and
when as information of the alarm or error with respect to the position icon, information representing one of a position specified by the position icon being out of range of movement of the industrial machine and the position being a singular point is acquired, the information display generation unit generates, for the position icon, a display that enables an occurrence of the alarm or error to be recognized.

9. The teaching device according to claim 5, wherein
as an icon constituting the control program, a first position icon and a second position icon having a function of specifying a position of the industrial machine are included, and
when as information of the alarm or error with respect to the first position icon and the second position icon, information representing one of a position of the industrial machine going out of range of movement and the position moving to a singular point in association with the industrial machine moving between a position specified by the first position icon and a position specified by the second position icon is acquired, the information display generation unit generates a display that enables an occurrence of the alarm or error to be recognized between the first position icon and the second position icon in the program creation screen.

10. The teaching device according to claim 1, wherein
the icon is an icon representing an instruction relating to processing using a visual sensor, and
the state information is information indicating whether an execution result of processing using the visual sensor is a success or failure.

11. The teaching device according to claim 10, wherein the information display generation unit performs one of operations of differentiating a display form of the icon according to whether the execution result is a success or failure, adding an image representing a different mark to the icon according to whether the execution result is a success or failure, and displaying a thumbnail of an image that serves as the execution result and is captured by the visual sensor in association with the icon.

12. The teaching device according to claim 1, wherein the state information is information indicating that setting of the icon includes at least one of an item that has not been set and an item a setting of which needs to be changed.

13. The teaching device according to claim 12, wherein the information display generation unit changes a display form to a first display form or adds an image representing a first mark with respect to an icon that is determined to have an item that has not been set and changes a display form to a second display form different from the first display form or adds an image representing a second mark different from the first mark with respect to an icon that is determined to have an item a setting of which needs to be changed.

14. The teaching device according to claim 12, wherein the information display generation unit generates a display relating to the icon in such a way that at least one of the number of items that have not been set in setting of the icon and the number of items settings of which needs to be changed in setting of the icon can be visually recognized.

15. The teaching device according to claim 1, further comprising a program generation unit configured to generate the program creation screen including a program creation region for creating the control program by sequentially arranging icons.

16. The teaching device according to claim 15, wherein the information display generation unit generates the display relating to the icon in the program creation region.

17. The teaching device according to claim 15, wherein
the program creation screen further includes a model image display screen in which a 3D model of the industrial machine that operates by execution of the control program is displayed, and
the information display generation unit generates a display relating to an execution result of the icon in the model image display screen.

18. The teaching device according to claim 17, wherein the information display generation unit generates the display in association with a position corresponding to a teaching position set in the icon in the model image display screen.
